(19) United States
(12) Patent Application Publication
(10) Pub. No.: US 2006/0224474 A1
(43) Pub. Date: Oct. 5, 2006

(54) Dimension sets

(75) Inventors: Kimberly Ann Nelson, Fargo, ND (US); Brett M. Lindemann, Fargo, ND (US); Ronald H. Schulz, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/093,896

(22) Filed: Mar. 30, 2005

(51) Int. Cl. G07F 19/00; G07B 17/00

(52) U.S. Cl. 705/30

(57) ABSTRACT

A computer-implemented accounting system provides user-definable transaction dimensions. An enterprise having a plurality of sub-units can define sets of transaction dimensions for use by the sub-units. Each sub-unit can specify a set defined by the enterprise for use and the display order for the set. A computer implemented method is also provided.

### BACKGROUND OF THE INVENTION

The present invention generally pertains to software applications that facilitate tracking corporate finances.

Modern business solutions software provides businesses with a vast array of powerful tools. Such solutions are known to provide integrated capabilities for financial management, distribution, manufacturing, project accounting, human resource management, field service management, and business analytics. Within such solutions, one aspect often provides automated business accounting functions.

Whether provided as a module in an integrated business solutions application, or as a stand-alone system, corporate accounting is configured to support conformance with some level of standardized accounting practices. Such software supports the use of balance sheets that provide a snapshot of a business' financial condition at a specific moment in time, usually at the close of an accounting period. Most accounting software also includes revenue, expense, and/or capital withdrawal accounts in the form of temporary accounts that are reset at the end of an accounting period so that they will have zero balances at the start of the next period.

Recently, accounting software has begun to provide user-definable transaction dimensions for improved tracking and business analytics. A user-definable transaction dimension is similar to a variable that contains additional information relative to a transaction. These user-definable transaction dimensions are used to classify, report, and analyze financial transactions based upon a user's specific business needs. The number of transaction dimensions that can be defined by a user are essentially unlimited and include such dimensions as cost center, profit center, region, and hours, as well as predefined system transaction dimensions such as customer, vendor, item, and site. These user-defined transaction dimension codes are attached to ledger transactions which eliminates the need to analyze transactions on the basis of account segments.

While the provision of user-definable transaction dimensions has provided a significant advance in the art of computer-implemented accounting systems, it is sometimes limited in large enterprise type applications. Specifically, a large enterprise, having two or more business sub-units, may define a set of transactions that the enterprise wishes to use. However, some transaction dimensions may not be applicable to all business sub-units of the enterprise. In such situations, the business sub-unit would still have a transaction dimension to essentially enter a null or blank into for each and every transaction. Though trivial, this extra step is or can be frustrating to users of such systems. Further, even though some business units may have identical dimension requirements, they may have different requirements for the manner in which they are displayed or ordered.

### SUMMARY OF THE INVENTION

A computer-implemented accounting system provides user-definable transaction dimensions. An enterprise having a plurality of sub-units can define sets of transaction dimensions for use by the sub-units. Each sub-unit can specify a set defined by the enterprise for use and the display order for the set. A computer implemented method is also provided.

### BRIEF DESCRIPTION OF THE DRAWINGS

FIG. 1 is a block diagram of a computing environment in which embodiments of the present invention may be implemented.

FIG. 2 is a schematic block diagram of a simplified financial record system.

FIG. 3 is a table illustrating a number of transactions tracked using a number of dimensions.

FIG. 4 is a diagrammatic view of a number of companies in an enterprise having various dimension sets in accordance with an embodiment of the present invention.

### DETAILED DESCRIPTION OF ILLUSTRATIVE EMBODIMENTS

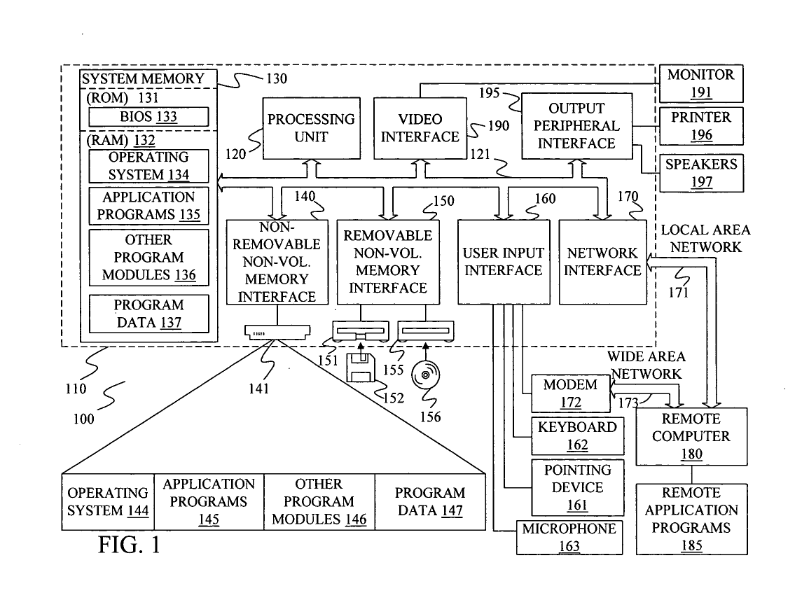

FIG. 1 illustrates an example of a suitable computing system environment 100 in which embodiments of the present invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

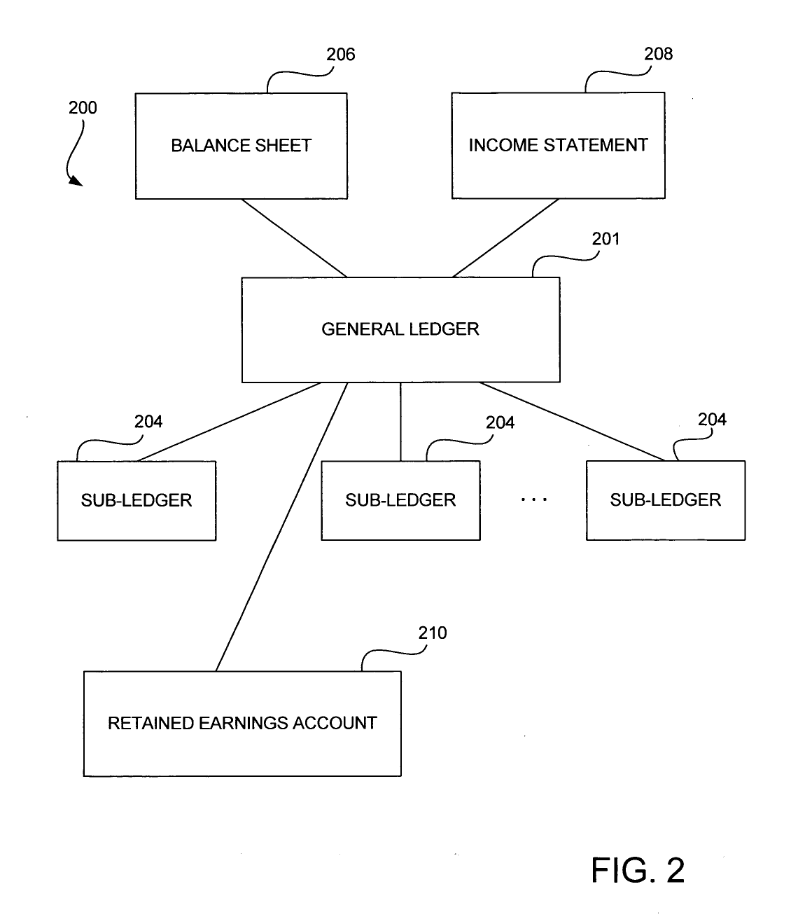

FIG. 2 is a schematic block diagram of a simplified financial record system 200 that represents one context within which embodiments of the present invention can be implemented. The core of system 200 is general ledger 201, which generally consists of a series of transactions stored on one or more suitable storage devices. All financial transactions flow through general ledger 201 so as to support the creation of a permanent financial history.

System 200 also includes a plurality of sub-ledgers 204 that track specific items such as cash, accounts receivable, accounts payable, payroll, inventory and the like. All entries posted to sub-ledgers 204 will transact through general ledger 201. For example, when a customer pays off a bill with cash, the transaction will be posted to the general ledger and the two appropriate sub-ledgers 204 (i.e., cash and accounts receivable).

Balance sheet 206 and income statement (sometime referred to as a “profit and loss” statement) 208 are financial documents that are drawn directly from general ledger 201. More specifically, general ledger 201 will contain the balances that make up line items on reports 206 and 208.

Balance sheet 206 is typically configured to provide an overview of financial condition at a given point in time such as at the close of an accounting period. The overview generally includes at least assets (anything the business owns) and liabilities (claims of creditors against assets of the business). In contrast, income statement 208 provides a profit/loss summary during a predetermined period of time, such as a month, quarter or one-year. The summary will generally include revenues and operating expenses for the business during the relevant time period.

It is common for system 200 to be implemented in the specific context of a software application. It should be noted that, for the purpose of illustrating basic components, system 200 is very simply presented. When actually applied in the context of real-world businesses, the structure of such a system can become quite complex, particularly when applied in the context of a large company having a sophisticated enterprise-oriented organization scheme.

Generally accounting software helps a business to conform with standardized accounting practices. Most applications include reporting functionality in the form of support for balance sheets and/or income statements. In addition, most applications also include revenue, expense, and/or capital withdrawal accounts in the form of temporary accounts that are reset at the end of an accounting period so that they will have zero balances at the start of the next period (commonly one year). Closing entries are the journal entries used to transfer balances of temporary accounts to permanent accounts. After the closing entries have been made, the temporary account balances will be reflected in a more permanent account such as a retained earnings account. A retained earnings account 210 is indicated in FIG. 2.

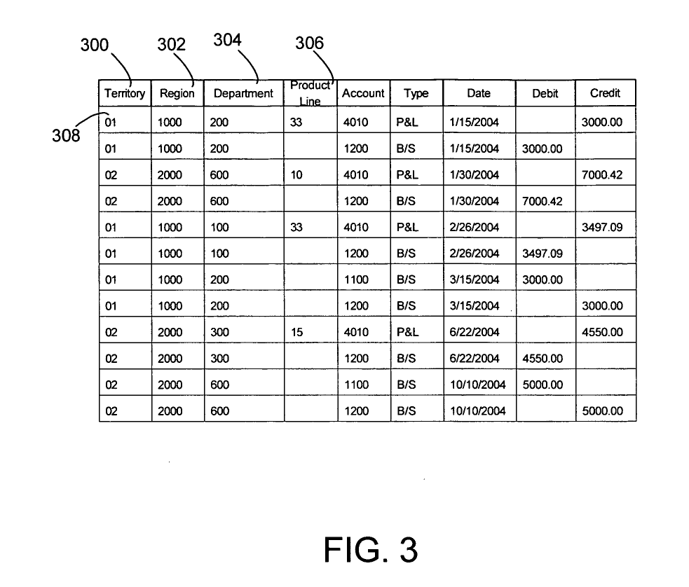

FIG. 3 is a table of journal entries illustrating the use of transaction dimensions. Specifically, the user has selected or otherwise defined four distinct dimensions illustrated in FIG. 3. Territory 300, region 302, department 304, and product line 306 are all user-defined transaction dimensions illustrated in FIG. 3. A given general ledger transaction line 308 is then augmented with information, to the extent known, relative to the dimensions. For example, transaction line 308 is augmented with territory information indicating that the transaction is related to territory 01, region information indicating region 1000, department information indicating department 200, and product information indicating product line 33. Additionally, each transaction line transacts relative to a selected account and the type of that account is listed, whether it be a profit and loss account (P&L) or a balance sheet (B/S) account.

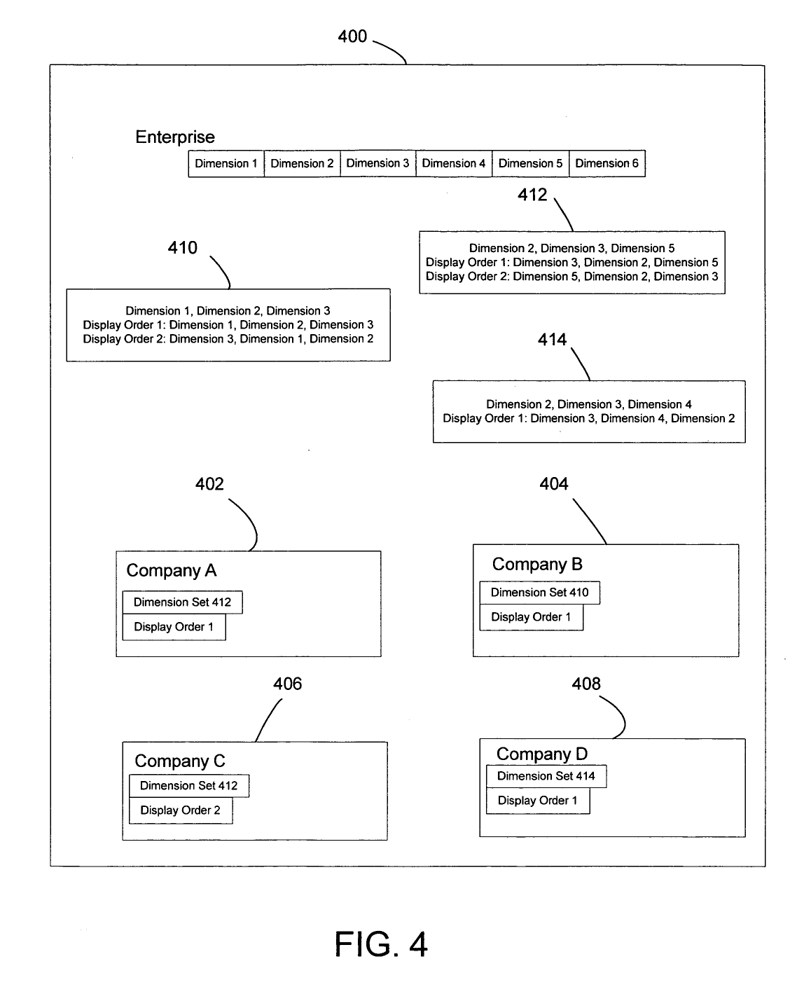

FIG. 4 is a diagrammatic view of an enterprise having various dimension sets in accordance with an embodiment of the present invention. Enterprise 400 has selected six transaction dimensions diagrammatically labeled Dimensions 1-6. Enterprise 400 has also created 3 dimension sets specific to the different types of sub-units that make up the enterprise and the data each type of sub-unit needs to track.

Dimension sets essentially provide the ability to define and label groups of dimensions. Users will be less error prone when defining dimensions for a given company because dimension sets provide for consistent reuse.

FIG. 4 shows sub-unit 402 (Company A) having selected the dimension set 412 containing dimensions 2, 3 and 5. Moreover, sub-unit 402 has specified a display order 1 such that the selected dimensions are displayed as Dimension 3, followed by Dimension 2, followed by Dimension 5. In contrast, sub-unit 404 (Company B), being of a different sub-unit type, has selected a different dimension set 410 than sub-unit 402. Instead, sub-unit 404 has Dimension 1, Dimension 2, and Dimension 3, appearing in display order 1. Sub-unit 406 (Company C) being the same sub-unit type as sub-unit 402 has selected the same dimension set 412 as sub-unit 402, but has specified a different display order 2. Specifically, sub-unit 406 provides Dimension 5, followed by Dimension 2, followed by Dimension 3. Finally, sub-unit 408 (Company D) being of yet a different sub-unit type selects a dimension set 414 consisting of Dimension 2, Dimension 3 and Dimension 4.

Thus, embodiments of the present invention allow different sub-units of an enterprise to select different sets of dimensions as well as a display order of the selected set. One reason that dimensions may need to be displayed differently is due to the layout of documentation that a given sub-unit uses to enter transactions. As illustrated in FIG. 4, each set of dimensions can have multiple display orders where each sub-unit using the dimension set would select one display order. The display order essentially sets the order in which the dimensions are presented to a user during transaction entry and other interfaces. It is believed that embodiments of the present invention will meet the overall needs of the enterprise while allowing a certain amount of customization at the sub-unit level to increase overall user acceptance of the accounting system.

Although the present invention has been described with reference to particular embodiments, workers skilled in the art will recognize that changes may be made in form and detail without departing from the spirit and scope of the invention. For example, while sub-unit are generally described with respect to different companies of an enterprise, they could be different divisions or groups within a single company.

What is claimed is:

1. A computer-implemented accounting system comprising:
a general ledger storage device configured to store a plurality of general ledger transactions;
an enterprise-defined set of transaction dimensions;
a first set of transaction dimensions having multiple first set display orders, wherein the first set is a subset of the enterprise-defined set; and
a second set of transaction dimensions having multiple second set display orders, wherein the second set is a different subset than the first set of the enterprise-defined set.

2. The accounting system of claim 1, wherein the first set display order is different than the second set display order.

3. The accounting system of claim 1, wherein the first set is different than the second set.

4. The accounting system of claim 1, wherein each sub-unit corresponds to a company within the enterprise.

5. The accounting system of claim 1, wherein transaction data relative to the first set is received from a user in one of the first set display orders.

6. The accounting system of claim 5, wherein transaction data relative to the second set is received from a user in one of the second set display orders.

7. A computer-implemented accounting method comprising:
defining a set of transaction dimensions;
defining at least one subset of the set of transaction dimensions; and
providing a plurality of display orders for the at least one subset.

8. The method of claim 7, wherein a plurality of subsets of the set are defined.

9. The method of claim 8, wherein the plurality of subsets are different.

10. The method of claim 9, wherein the set of transaction dimensions is an enterprise-defined set of transaction dimensions.

11. The method of claim 10, wherein each subset is defined by the enterprise.
